(19) United States
(12) Patent Application Publication
(10) Pub. No.: US 2015/0138352 A1
(43) Pub. Date: May 21, 2015

(54) IMAGE PROCESSING DEVICE, SYSTEM, IMAGE PROCESSING METHOD

(71) Applicant: Kabushiki Kaisha Toshiba, Minato-ku (JP)

(72) Inventors: Takayuki Itoh, Kawasaki (JP); Tomoya Kodama, Kawasaki (JP)

(73) Assignee: Kabushiki Kaisha Toshiba, Minato-ku (JP)

(21) Appl. No.: 14/534,634

(22) Filed: Nov. 6, 2014

(30) Foreign Application Priority Data
Nov. 20, 2013 (JP) 2013-239973

(51) Int. Cl. G01B 11/14

(52) U.S. Cl. CPC G01B 11/14
USPC 348/139

(57) ABSTRACT

According to an embodiment, an image processing device includes a processor and a memory. The processor acquires a first image captured at a first timing by an imager that is mounted on a movable body. The processor acquires a range image that represents a distance to a subject. The processor estimates a difference in viewpoint of the imager between at the first timing and at a second timing that is different than the first timing, based on movement information of the movable body. The processor generates a second image that is predicted to be captured by the imager at the second timing based on the first image, the range image, and the difference in viewpoint.

### CROSS-REFERENCE TO RELATED APPLICATION

This application is based upon and claims the benefit of priority from Japanese Patent Application No. 2013-239973, filed on Nov. 20, 2013; the entire contents of which are incorporated herein by reference.

### FIELD

Embodiments described herein relate generally to an image processing device, a system, and an image processing method.

### BACKGROUND

Typically, a system is known that enables an operator to operate a movable body from a remote location. In such a system, the operator operates the movable body while, for example, checking the images taken by an image capturing device mounted on that movable body.

In this case, due to a reason such as a transmission delay of the network, there occurs a delay between a timing at which an image is taken and a timing at which that image is displayed. For this reason, there occurs a mismatch between the actually-displayed image and the image taken at the current position of the movable body. Hence, in a case where there is a long delay, at the time of performing an operation to move the movable body while checking the displayed image, the operation timing becomes delayed, thereby making it difficult to perform an accurate operation.

There exists a technology that enables zooming of a received image or shifting of a received image in the vertical, horizontal, and oblique directions based on sensor information such as a delay estimate time, the travelling speed of the movable body, the blur angle of the movable body, and the battery voltage value. However, if such operations are performed without taking into account the positional relationship between the movable body and the photographic subject, then there are times when a large degree of mismatch occurs between the image that is supposed to be displayed and the actually-displayed image.

For this reason, even if there occurs a delay between the timing at which an image is taken and the timing at which that image is displayed, it is desirable to be able to display an image that has only a small mismatch with the image taken from the movable body at the current position.

### BRIEF DESCRIPTION OF THE DRAWINGS

FIG. 1 is a diagram illustrating a remote control system according to an embodiment;

FIG. 2 is a diagram illustrating hardware of the remote control system according to the embodiment;

FIG. 3 is a diagram illustrating the remote control system according to the embodiment;

FIG. 4 is a flowchart for explaining operations performed in the remote control system according to the embodiment;

FIG. 5 is a diagram illustrating the remote control system according to a first modification;

FIG. 6 is a diagram illustrating the remote control system according to a second modification;

FIG. 7 is a diagram illustrating the remote control system according to a third modification; and

FIG. 8 is a diagram illustrating an example of the transmission cycle and the display cycle.

### DETAILED DESCRIPTION

According to an embodiment, an image processing device includes a processor and a memory. The processor acquires a first image captured at a first timing by an imager that is mounted on a movable body. The processor acquires a range image that represents a distance to a subject. The processor estimates a difference in viewpoint of the imager between at the first timing and at a second timing that is different than the first timing, based on movement information of the movable body. The processor generates a second image that is predicted to be captured by the imager at the second timing based on the first image, the range image, and the difference in viewpoint.

An exemplary embodiment of the invention is described in detail with reference to the accompanying drawings. In the following embodiment, the constituent elements referred to by the same reference numerals perform the same operations, and the explanation thereof is not repeated except for the differences.

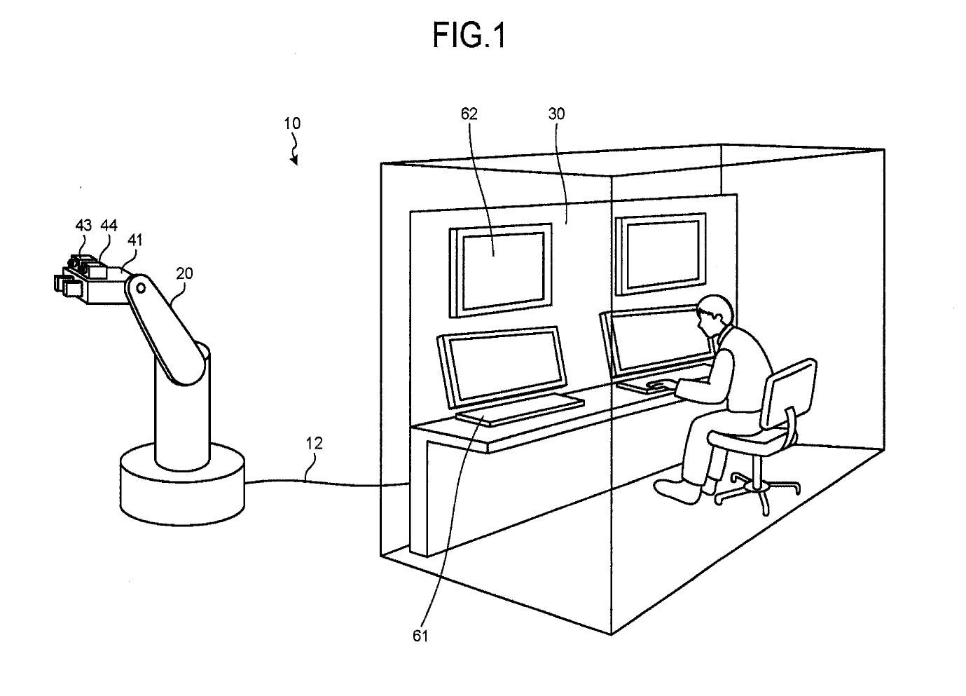

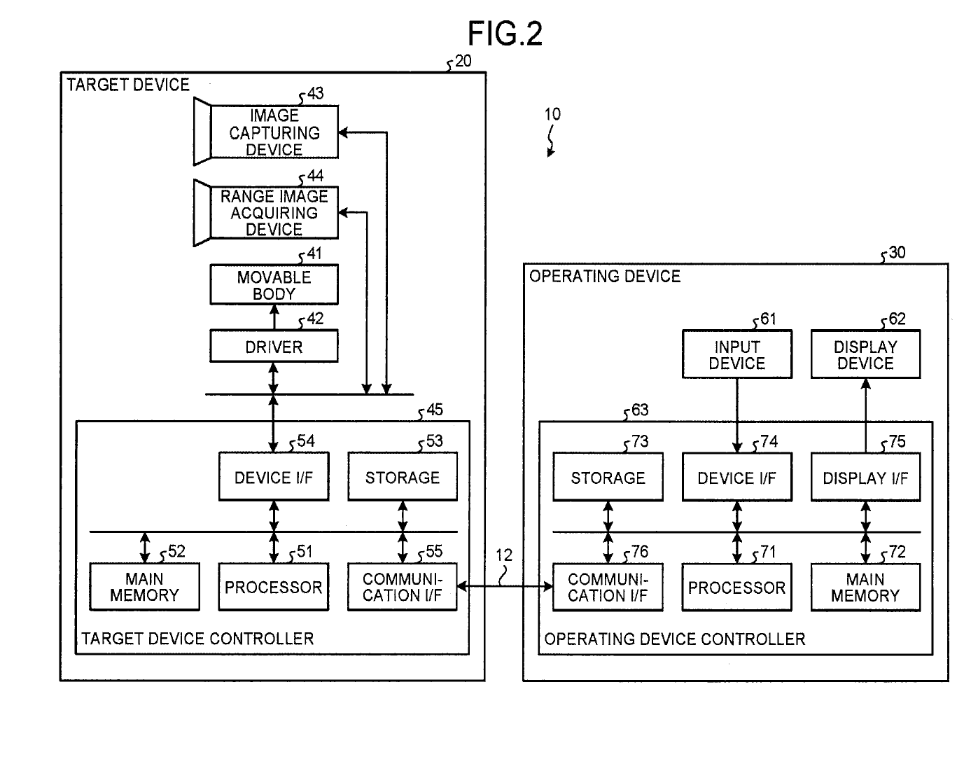

FIG. 1 is a diagram illustrating a remote control system 10 according to the embodiment. FIG. 2 is a diagram illustrating hardware of the remote control system 10.

The remote control system 10 includes a target device 20 and an operating device 30, which is used by an operator to remotely operate the target device 20. The target device 20 and the operating device 30 are connected to each other through a network 12, which can be a wired network or a wireless network. Moreover, the network 12 can be a dedicated network line or can be a publicly-usable network line such as the Internet.

The target device 20 is remotely-controllable through the network 12. As an example, the target device 20 is a robotic arm. Other examples of the target device 20 include an automobile (including a model), an airplane (including a model), a helicopter (including a model), a boat (including a model), and various types of robots.

As illustrated in FIG. 2, the target device 20 includes a movable body 41, a driver 42, an image capturing device (imager) 43, a range image acquiring device 44, and a target device controller 45.

The movable body 41 moves under remote control. If the target device 20 is a robotic arm, then the movable body 41 is, for example, the arm portion. Alternatively, if the target device 20 is an automobile, an airplane, a helicopter, or a boat; then the movable body 41 is, for example, the auto-movable body or the airframe.

The driver 42 is used for the purpose of moving the movable body 41. As an example, the driver 42 is an actuator, a motor, or an engine. Moreover, the driver 42 can also include a device for changing the direction of movement of the movable body 41 and a brake for stopping the movement of the movable body 41.

The image capturing device 43 is mounted on the movable body 41, and generates images by capturing photographic subjects from the movable body 41. Thus, depending on the movement zone of the movable body 41, there is a change in the imaging viewpoint (the imaging position and the imaging direction) of the image capturing device 43.

The image capturing device 43 converts the figure of a photographic subject into an image. As an example, the image capturing device 43 is a visible light camera that captures the visible light coming from the photographic subject. Alternatively, the image capturing device 43 can be an infrared camera that captures the infrared light coming from the photographic subject, or can be an ultraviolet light camera that captures the ultraviolet light coming from the photographic subject, or can be an ultrasonic camera that detects ultrasonic waves coming from the photographic subject and converts the ultrasonic waves into an image. Moreover, in order to enable taking pictures in a dark place too, the image capturing device 43 can include a device that emits light (such as visible light, infrared light, or ultraviolet light) to the photographic subject. Similarly, if the image capturing device 43 is an ultrasonic camera, it can include a device that generates ultrasonic waves.

The range image acquiring device 44 detects a range image (a depth image) that represents the distance from a reference position to the photographic subject being captured by the image capturing device 43. In the movable body 41, the range image acquiring device 44 is disposed at a position from which it is possible to detect the distance from the reference position to the photographic subject to be captured by the image capturing device 43. For example, in the movable body 41, the range image acquiring device 44 is disposed at an almost identical position to the position of the image capturing device 43 and in an almost identical imaging direction to the imaging direction of the image capturing device 43. Herein, for example, the reference position points to the imaging position of the image capturing device 43. However, if the positional relationship with the image capturing device 43 is fixed, the reference position can be a position other than the imaging position of the image capturing device 43.

For each pixel unit (or for each area unit including a certain number of pixels) of a photographic subject image taken by the image capturing device 43, the range image acquiring device 44 generates a range image that indicates the distance to the photographic subject. Herein, as an example, the range image acquiring device 44 is a Time-of-Flight range image sensor or a pattern-radiation-type range image sensor.

The target device controller 45 is equipped with a function of communicating with the operating device 30 through the network 12 and a function of controlling the driver 42. Moreover, the target device controller 45 is equipped with a function of encoding and transmitting the photographic subject images, which are taken by the image capturing device 43, and the range images, which are acquired by the range image acquiring device 44.

The target device controller 45 has the hardware configuration identical to a commonplace computer, and can be configured to implement some or all of the abovementioned functions by executing preinstalled computer programs. In this case, as an example, the target device controller 45 includes a processor 51, a main memory 52, a storage 53, a device I/F 54, and a communication I/F 55.

The processor 51 is a central processing unit (CPU) that performs data processing and control processing according to computer programs. The main memory 52 is a random access memory (RAM) that functions as the work area of the processor 51. The storage 53 is a nonvolatile data storage such as a read only memory (ROM) or a hard disk drive (HDD) in which computer programs to be executed by the processor 51 are stored in advance. The device I/F 54 is an interface for communicating data with the driver 42, the image capturing device 43, and the range image acquiring device 44 within the target device 20. The communication I/F 55 is an interface for communicating information with the operating device 30 through the network 12.

The hardware configuration of the target device 20 is only exemplary, and it is also possible to have some other configuration. Moreover, the target device controller 45 either can be disposed inside the main body of the target device 20 or can be disposed separately from the main body of the target device 20. Furthermore, the target device 20 can separately include another controller that, independent of the target device controller 45, encodes and transmits the images acquired by the image capturing device 43 and the range image acquiring device 44.

The operating device 30 is operated by an operator to remotely control the target device 20 through the network 12. As an example, the operating device 30 is installed in an operation room that is away from the installation site of the target device 20.

As illustrated in FIG. 2, the operating device 30 includes an input device 61, a display device 62, and an operating device controller 63. The input device 61 includes various devices such as a keyboard, a mouse, switches, a handle, a slide bar, and a volume knob that enable the operator to input information.

The display device 62 displays images to the operator. Besides, the display device 62 can also be configured to display a variety of information to the operator.

The operating device controller 63 is equipped with a function of communicating with the target device 20 through the network 12; and a function of generating control information, which is used in performing movement control of the movable body 41 according to an input from the operator, and transmitting the control information to the target device 20. Moreover, the operating device controller 63 is equipped with a function of receiving an encoded photographic subject image and an encoded range image from the target device 20 and decoding those images; and a function of generating a photographic subject image in which delay compensation is done based on the decoded photographic subject image and the decoded range image, and displaying the generated photographic subject image on the display device 62.

As an example, the operating device controller 63 has the hardware configuration identical to a commonplace computer, and can be configured to implement some or all of the abovementioned functions by executing preinstalled computer programs. In this case, as an example, the operating device controller 63 includes a processor 71, a main memory 72, a storage 73, a device I/F 74, a display I/F 75, and a communication I/F 76.

The processor 71 is a CPU that performs data processing and control processing according to computer programs. The main memory 72 is a RAM that functions as the work area of the processor 71. The storage 73 is a nonvolatile data storage such as a ROM or an HDD in which computer programs to be executed by the processor 71 are stored in advance. The device I/F 74 is an interface for obtaining the information input from the input device 61. The communication I/F 76 is an interface for communicating information with the target device 20 through the network 12.

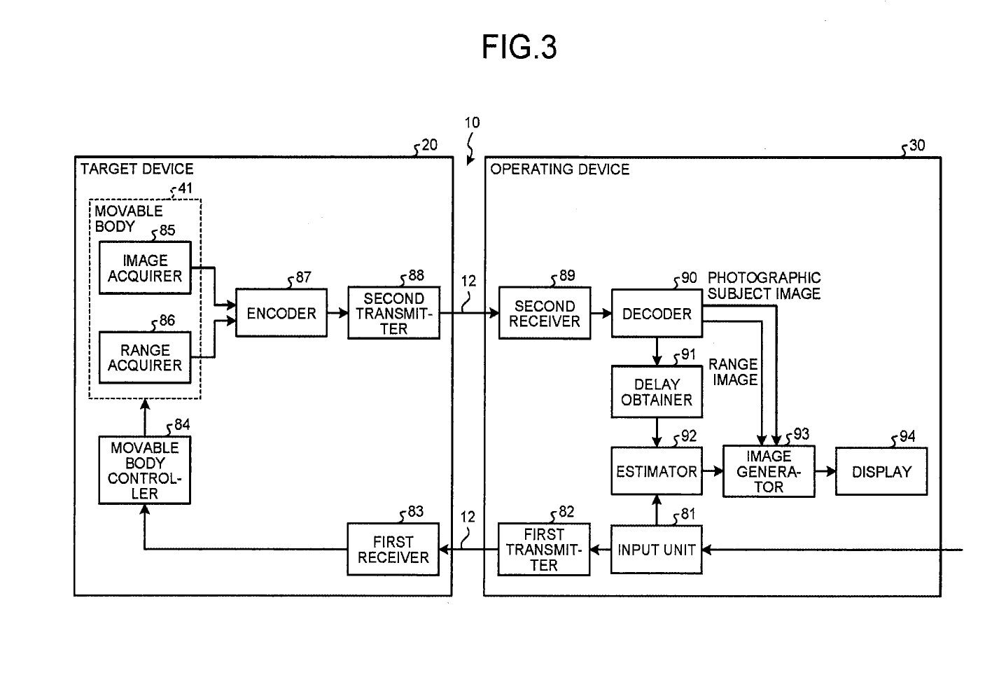

FIG. 3 is a diagram illustrating the remote control system 10 according to the embodiment. Thus, the target device 20 and the operating device 30 have the configuration illustrated in FIG. 3. In the remote control system 10, image processing is performed with respect to photographic subject images that are taken, and the processed images are displayed.

More particularly, the target device 20 includes a first receiver 83, a movable body controller 84, an image acquirer 85, a range acquirer 86, an encoder 87, and a second transmitter 88. The operating device 30 includes an input unit 81, a first transmitter 82, a second receiver (communicator) 89, a decoder 90, a delay obtainer 91, an estimator 92, an image generator 93, and a display 94.

The input unit 81 receives input of the control information, which is used for the purpose of moving the movable body 41, from the operator. The first transmitter 82 transmits the control information, which is received by the input unit 81, to the target device 20 through the network 12. The first receiver 83 receives the control information from the operating device 30 through the network 12. The movable body controller 84 moves the movable body 41 according to the control information received by the first receiver 83. As a result, in the remote control system 10, the movable body 41 of the target device 20 can be moved according to the operations of the operator.

The image acquirer 85 acquires a photographic subject image (a first image) captured at a first timing by the image capturing device 43 mounted on the movable body 41. The range acquirer 86 acquires a range image that represents the distance from the reference position to the photographic subject captured by the image capturing device 43. In this example, the range acquirer 86 acquires the range image that is detected by the range image acquiring device 44.

The encoder 87 encodes the photographic subject image, which is acquired by the image acquirer 85, and the range image, which is acquired by the range acquirer 86, according to a predetermined method. As an example, the encoder 87 encodes images using JPEG (Joint Photographic Experts Group), Moving Picture Experts Group (MPEG)-2, or H.264/AVC or H.265/HEVC. The second transmitter 88 transmits the photographic subject image and the range image, which are encoded by the encoder 87, to the operating device 30 through the network 12.

The second receiver 89 receives the encoded photographic subject image and the encoded range image that are transmitted from the target device 20. The decoder 90 decodes the encoded photographic subject image and the encoded range image, which are received by the second receiver 89, according to the same method that is implemented for encoding. As an example, the decoder 90 decodes the images using JPEG, MPEG-2, or H.264/AVC or H.265/HEVC.

Meanwhile, the configuration can be such that the target device 20 and the operating device 30 do not include the encoder 87 and the decoder 90, respectively. That is, the second transmitter 88 and the second receiver 89 can respectively transmit and receive un-encoded photographic subject images and un-encoded range images.

The delay obtainer 91 obtains a delay time from a first timing, at which a photographic subject image is taken, to a second timing that is different than the first timing. As an example, the second timing indicates a time at which the photographic subject image (a predicted image) should be displayed on a display. Thus, in this case, the delay obtainer 91 obtains a delay time that includes delays caused by an image processing operation, an encoding operation, a transmitting operation, a receiving operation, a decoding operation, and an image displaying operation that are performed since the timing of taking a photographic subject image up to the timing of displaying that photographic subject image. Meanwhile, the second timing is not limited to the timing at which the photographic subject image is displayed. Alternatively, the second timing can be a timing before or after the timing at which the photographic subject should be displayed.

For example, the delay obtainer 91 can obtain the delay time by reading a premeasured value from a memory. Alternatively, at the start of the operations of the remote control system 10 or during the operations of the remote control system 10, the delay obtainer 91 can periodically measure a roundtrip delay time between the second transmitter 88 and the second receiver 89, and calculate the delay time based on the measurement result. As a result of performing such measurement, it becomes possible for the delay obtainer 91 to obtain an accurate delay time corresponding to the communication status of the network 12.

Still alternatively, the delay obtainer 91 can calculate the delay time based on a timestamp that represents the timing at which a photographic subject image is taken. In this case, in addition to acquiring a photographic subject image, the image acquirer 85 acquires the timestamp that represents the timing at which that photographic subject image was taken by the image capturing device 43. Then, the second transmitter 88 obtains the timestamp from the image acquirer 85, and transmits the timestamp to the operating device 30 along with the encoded photographic subject image and the encoded range image. Thus, the second receiver 89 receives the timestamp along with the encoded photographic subject image and the encoded range image. Then, the delay obtainer 91 detects the difference between the timing managed by the operating device 30 and the timing indicated in the timestamp; and calculates the delay time based on the detected difference. As a result, even in the case in which the delay time changes for each photographic subject image, the delay obtainer 91 can obtain the delay time with accuracy.

On the basis of the movement information of the movable body 41 and the delay time obtained by the delay obtainer 91, the estimator 92 estimates the difference in viewpoint of the image capturing device 43 between at the first timing at which the photographic subject image is taken and at the second timing at which, for example, the photographic subject image should be displayed.

While the movable body is moving, the imaging viewpoint of the image capturing device 43 keeps on changing. Hence, when there is a delay time, at the timing at which the photographic subject image should be displayed (for example, at the second timing), the imaging viewpoint of the image capturing device 43 differs from the imaging viewpoint at the timing at which the photographic subject image was taken (i.e., at the first timing). The estimator 92 estimates such a difference in the viewpoint on the basis of the movement information of the movable body 41 and the delay time.

Herein, the difference in viewpoint is at least one of the following: a three-dimensional position difference between the imaging position of the image capturing device 43 at the first timing and the imaging position of the image capturing device 43 at the second timing; and a three-dimensional angle difference between the imaging direction of the image capturing device 43 at the first timing and the imaging direction of the image capturing device 43 at the second timing. For example, if the movable body 41 is configured to perform linear movement but riot configured to perform rotational movement, the difference in viewpoint is represented with the amount of three-dimensional parallel movement of the imaging position (i.e., the amount of translation in the three-dimensional coordinates). In contrast, if the movable body 41 is configured to perform rotational movement but not configured to perform linear movement, the difference in viewpoint is represented with the amount of three-dimensional rotation of the imaging direction (the amount of rotation in the three-dimensional coordinates). However, if the movable body 41 is configured to move in the space in an intricate manner, the difference in viewpoint is represented with the amount of three-dimensional parallel movement of the imaging position as well as the amount of three-dimensional rotation of the imaging direction.

As an example, as the movement information of the movable body 41, the estimator 92 acquires the control information that is acquired by the input unit 81. Alternatively, in the case in which the control information is generated according to a computer program set in advance, the estimator 92 can generate the movement information based on that control program. Still alternatively, as the movement information of the movable body 41, the estimator 92 can acquire, from outside, image information or sensor information indicating the movement of the movable body 41.

Then, as an example, the estimator 92 calculates the difference in viewpoint in the following manner. Firstly, based on the movement information that is acquired, the estimator 92 estimates the difference between the imaging viewpoint (the imaging position and the imaging direction) at the first timing, at which the photographic subject image was taken, and the imaging viewpoint (the imaging position and the imaging direction) at the second timing that comes after the first timing by a period of time equal to the delay time obtained by the delay obtainer 91 (i.e., estimates the difference in the imaging position and the difference in the imaging direction). Then, based on the difference in the imaging viewpoints, the estimator 92 calculates the difference in viewpoint.

Based on the photographic subject image and the range image that are decoded by the decoder 90 and based on the difference in viewpoint that is estimated by the estimator 92, the image generator 93 generates a predicted image (a second image) that is predicted to be taken by the image capturing device 43 at the second timing.

The image generator 93 synthesizes photographic subject image data (i.e., image data formed by assigning pixel values to two-dimensional coordinates) and range image data (i.e., data formed by assigning ranges to two-dimensional coordinates) using predetermined parameters, and converts the synthesized data into three-dimensional image data (i.e., image data formed by assigning pixel values to three-dimensional space coordinates). For example, the image generator 93 generates three-dimensional image data using an arithmetic expression given below in Equation (1).

$$( \begin{matrix}X \\ Y \\ Z\end{matrix} ) = {A}^{- 1} ( \begin{matrix}x \\ y \\ 1\end{matrix} ) z \qquad ( 1 )$$

Herein, (x, y, 1) represents coordinates (x, y) in the photographic subject image. Moreover, “z” represents the distance from the reference position of the coordinates (x, y) to the photographic subject. Furthermore, “A” represents a parameter used in perspective projection transformation of the pixel values of the three-dimensional space coordinates into the pixel values of the two-dimensional coordinates. Moreover, “A ” represents a parameter used in inverse transformation of “A”. Furthermore, (X, Y, Z) represents coordinates in the three-dimensional space. When the value of the pixel at each set of coordinates (x, y) in the photographic subject image is assigned to the three-dimensional space coordinates (X, Y, Z), it results in the generation of the three-dimensional image data.

Then, with respect to the post-transformation three-dimensional image data, the image generator 93 performs a viewpoint transformation operation corresponding to the difference in viewpoint between at the first timing and at the second timing (i.e., corresponding to at least either the difference in the imaging positions or the difference in the imaging directions). That is, the image generator 93 transforms the three-dimensional image data, which is acquired by viewing the photographic subject from the imaging viewpoint at the first timing, into the three-dimensional image data that is acquired by viewing the photographic subject from the imaging viewpoint at the second timing. Subsequently, based on predetermined parameters, the image generator 93 breaks down the post-viewpoint-transformation three-dimensional image data into two-dimensional image data and range image data.

For example, the image generator 93 performs a viewpoint transformation operation and a breakdown operation using an arithmetic expression given below in Equation (2).

$${z}^{′} ( \begin{matrix}{x}^{′} \\ {y}^{′} \\ 1\end{matrix} ) = A \{ R ( \begin{matrix}X \\ Y \\ Z\end{matrix} ) + t \} \qquad ( 2 )$$

Herein “R” and “t” are parameters representing the difference in viewpoint between at the first timing and at the second timing. More particularly, “R” represents the difference in the directions of the imaging viewpoints (represents the amount of rotation in the three-dimensional coordinates); while “t” represents the difference in the positions of the imaging viewpoints (represents the amount of translation in the three-dimensional coordinates). Moreover, (x′, y′, 1) represents coordinates (x′, y′) in the post-viewpoint-transformation photographic subject image. When the value of the pixel at each set of three-dimensional space coordinates (X, Y, Z) is assigned to the coordinates (x′, y′) in the photographic subject image; it results in the generation of the photographic subject image.

Then, the image generator 93 outputs the two-dimensional image, which is generated in the manner described above, as the predicted image that is predicted to be taken by the image capturing device 43 at the second timing.

In this way, as a result of using the range image, the image generator 93 can perform a viewpoint transformation operation in the three-dimensional space coordinates. Hence, as compared to performing viewpoint transformation by means of shifting and enlarging/reducing a two-dimensional image, the image generator 93 can perform viewpoint transformation with accuracy. Meanwhile, the image generator 93 is not limited to perform the operations based on perspective projection transformation, and can perform transformation of difference in viewpoint by implementing other methods.

Besides, in addition to transforming the imaging viewpoints, the image generator 93 can also perform various operations such as interpolation, noise removal, and upsampling. Moreover, in the case in which the movable body 41 is not moving and there is no difference in viewpoint, the image generator 93 need not perform the viewpoint transformation operation.

The display 94 displays, to the operator, the predicted image that is generated by the image generator 93 and that is predicted to be taken by the image capturing device 43 at the second timing.

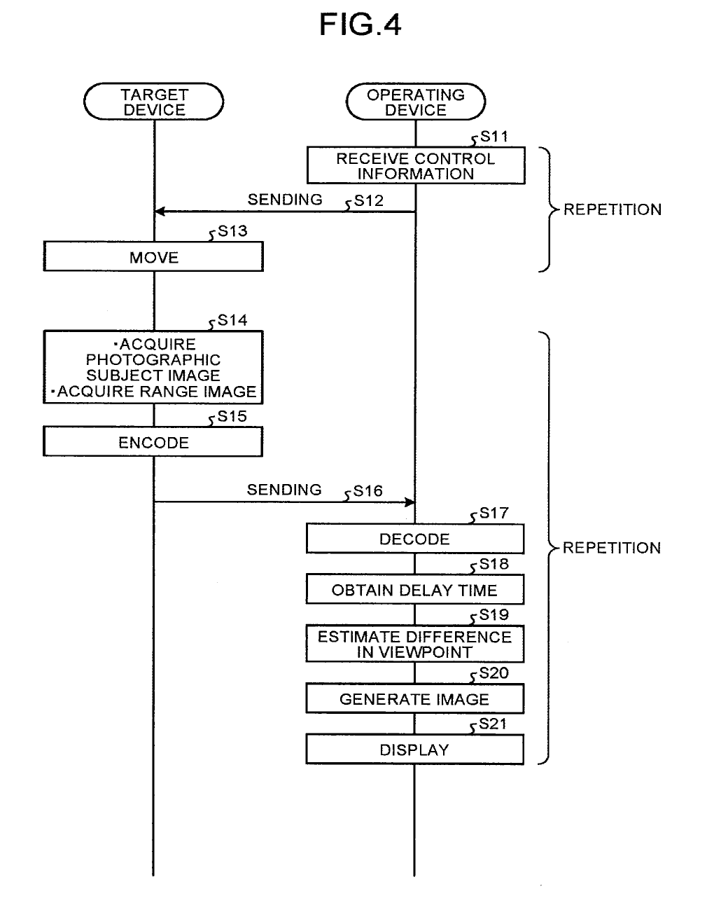

FIG. 4 is a flowchart for explaining operations performed in the remote control system 10 according to the embodiment.

Firstly, the operating device 30 receives input of the control information (Step S11). Then, the operating device 30 transmits the control information to the target device 20 through the network 12 (Step S12).

Thus, the target device 20 receives the control information from the operating device 30 (Step S12). Then, the target device 20 moves the movable body 41 according to the received control information (Step S13). Every time a set of control information is input, the target device 20 and the operating device 30 repeat the operations from Step S11 to Step S13. As a result, the remote control system 10 can move the movable body 41 according to the input of each set of control information.

Meanwhile, the target device 20 acquires a photographic subject image. Along with that, the target device 20 acquires a range image (Step S14).

Then, the target device 20 encodes the photographic subject image and the range image (Step S15). Subsequently, the target device 20 transmits the encoded photographic subject image and the encoding range image to the operating device 30 the network 12 (Step S16).

Thus, the operating device 30 receives the encoded photographic subject image and the encoded range image from the target device 20 through the network 12 (Step S16). Then, the operating device 30 decodes the encoded photographic subject image and the encoded range image, and acquires the photographic subject image and the range image (Step S17).

Subsequently, the operating device 30 obtains the delay time from the timing at which the photographic subject image is acquired to the timing at which the photographic subject image is displayed (Step S18). Then, based on the movement information of the movable body 41 and the obtained delay time, the operating device 30 estimates difference in viewpoint between the image capturing device 43 at the first timing, at which the photographic subject image is taken, and the image capturing device 43 at the second timing, at which the photographic subject image should be displayed (Step S19).

Subsequently, based on the decoded photographic subject image and the decoded range image as well as based on the estimated difference in viewpoint, the operating device 30 generates a predicted image that is predicted to be taken by the image capturing device 43 at the second timing (Step S20). Then, the operating device 30 displays the predicted image that is predicted to be taken by the image capturing device 43 at the second timing (Step S21). Thereafter, for each transmission cycle, the target device 20 and the operating device 30 repeat the operations from Step S14 to Step S21.

In this way, even when there exists a delay time from the timing at which a photographic subject image is taken to the timing at which the photographic subject image is displayed, the remote control system 10 predicts the image that is to be taken from the movable body 41 for displaying purposes and displays the predicted image. Hence, in the remote control system 10, the operator can be provided with a photographic subject image in which the delay time that occurs between capturing an image and displaying the image has been compensated. As a result, in the remote control system 10, it becomes possible to enhance the operability of the operator.

Particularly, in the remote control system 10, with the use of a range image, a viewpoint transformation operation is performed in the three-dimensional space and a predicted image is generated. Hence, in the remote control system 10, it becomes possible to display a predicted image that has only a small mismatch with the image taken from the movable body 41. For example, even in the case in which the movable body 41 is configured to perform a complex movement, it becomes possible to display a predicted image in which the movement is compensated.

Meanwhile, the configuration can also be such that the delay obtainer 91 obtains the delay time which includes the delay from the timing at which the operator inputs the control information to the timing at which the movable body 41 moves. That is, as the delay time, the delay obtainer 91 can treat the period of time obtained by adding the amount of time from the timing of inputting the control information to the timing at which the movable body 41 moves to the amount of time from the timing of taking a photographic subject image to the timing of displaying that photographic subject image. As a result, it becomes possible for the remote control system 10 to provide the operator with a photographic subject image in which the delay from the timing of an operation input to the timing of movement of the movable body 41 is compensated. That enables achieving enhancement in the operability.

First Modification

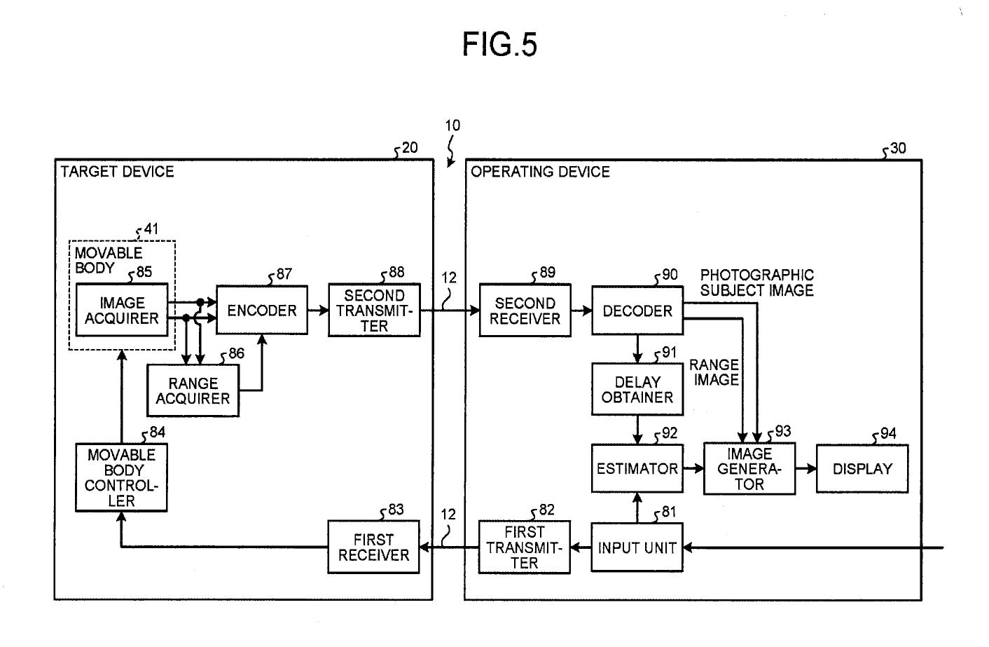

FIG. 5 is a diagram illustrating the remote control system 10 according to a first modification.

According to the first modification, the image acquirer 85 acquires two or more photographic subject images having mutually different parallaxes (i.e., acquires parallax images). For example, the image acquirer 85 acquires the parallax images from a plurality of the image capturing devices 43, such as from a stereo camera. Alternatively, the image acquirer 85 can acquire the parallax images from the image capturing device 43 that includes a lens array for forming two or more images on a single imaging element.

According to the first modification, the range acquirer 86 acquires a range image from the parallax images acquired by the image acquirer 85. As an example, the range acquirer 86 calculates, from the parallax images, the amount of parallax at each position in the parallax images by means of block matching; and generates a range image. Thus, according to the first modification, the target device 20 need not include the range image acquiring device 44 in the movable body 41.

The encoder 87 encodes the parallax images and the range image. Herein, the encoder 87 either can separately encode each of the two or more photographic subject images representing the parallax images, or can perform encoding by implementing a method (such as H.264/MVC) for encoding parallax images.

The decoder 90 decodes the encoded parallax images and the encoded range image. The image generator 93 performs a viewpoint transformation operation with respect to the parallax images. The display 94 displays the parallax images that have been subjected to viewpoint transformation.

Thus, according to the first modification, the remote control system 10 can provide the operator with a photographic subject image in which the delay from the timing of an operation input to the timing of movement of the movable body 41 is compensated. Besides, according to the first modification, since the remote control system 10 can generate a range image from the photographic subject images, it eliminates the need of having the range image acquiring device 44. Hence, the configuration becomes simpler.

Meanwhile, in the first modification, the range acquirer 86 can be disposed in the operating device 30 instead of disposing it in the target device 20. In that case, the range acquirer 86 generates a range image from the parallax images decoded by the decoder 90. However, while generating a range image from the parallax images, there is a possibility of an increased volume of operations. Hence, if the range acquirer 86 is included in the operating device 30, it becomes possible to reduce the calculation resources of the target device 20, thereby making the configuration of the target device 20 simpler.

Second Modification

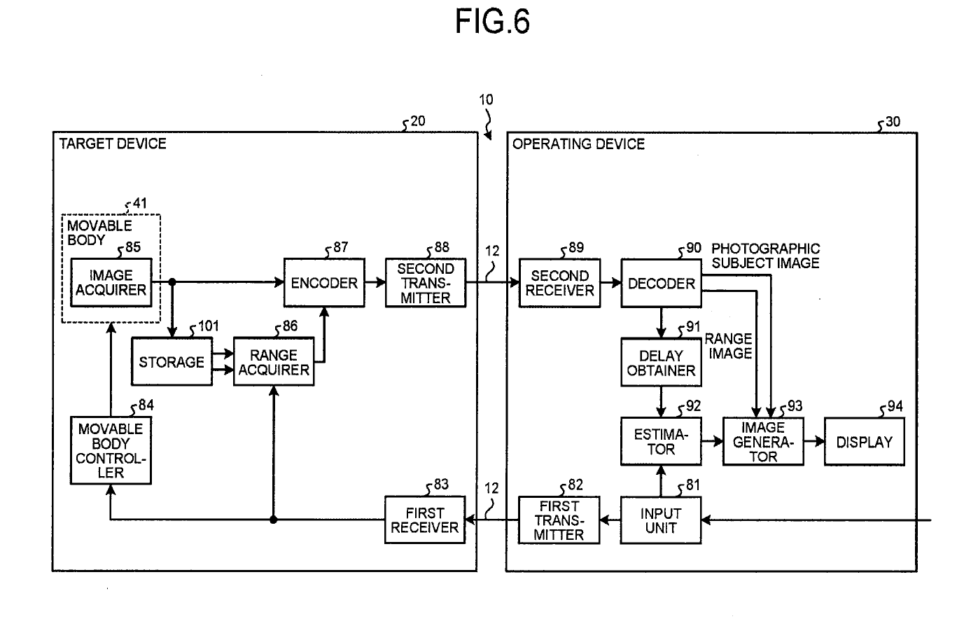

FIG. 6 is a diagram illustrating the remote control system 10 according to a second modification.

According to the second modification, the target device 20 further includes a storage 101 that is used to store the photographic subject images, which are acquired by the image acquirer 85, for a predetermined period of time. As an example, during a period of time in which the image acquirer 85 is outputting a predetermined number of photographic subject images, the storage 101 is used to store the photographic subject images.

According to the second modification, the range acquirer 86 generates a range image based on the motion parallaxes of two or more photographic subject images taken at different timings. More particularly, the range acquirer 86 reads, from the storage 101, two or more photographic subject images taken at different timings (for example, two or more consecutive photographic subject images that are recently stored in the storage 101). Then, the range acquirer 86 acquires the movement information of the movable body 41 during the period of time of taking the two or more photographic subject images. For example, from the first receiver 83, the range acquirer 86 acquires control information that instructs the movement of the movable body 41 during the period of time of taking the two or more photographic subject images that are read.

From the movement information of the movable body 41, the range acquirer 86 calculates the distance between the imaging viewpoints at the timing of taking each of the two or more photographic subject images that are taken at different timings. Then, the range acquirer 86 calculates a range image by referring to the two or more photographic subject images that are taken at different timings and the distances between the imaging viewpoints. As an example, the range acquirer 86 calculates the amount of parallax at each position in the photographic subject images by means of block matching, and generates a range image. Thus, according to the second modification example, the target device 20 need not include the range image acquiring device 44 in the movable body 41.

In this way, according to the second modification, the remote control system 10 can provide the operator with a photographic subject image in which the delay from the timing of taking a photographic subject image to the timing of displaying the photographic subject image is compensated. Besides, according to the second modification example, since the remote control system 10 can generate a range image from the photographic subject images, it eliminates the need of having the range image acquiring device 44. Hence, the configuration becomes simpler.

Meanwhile, in the second modification, the storage 101 and the range acquirer 86 can be disposed in the operating device 30 instead of disposing them in the target device 20. In that case, the storage 101 is used to store two or more photographic subject images decoded by the decoder 90. Meanwhile, while generating a range image from the parallax images, there is a possibility of an increased volume of operations. Hence, if the range acquirer 86 is included in the operating device 30, it becomes possible to reduce the calculation resources of the target device 20, thereby making the configuration of the target device 20 simpler.

Third Modification

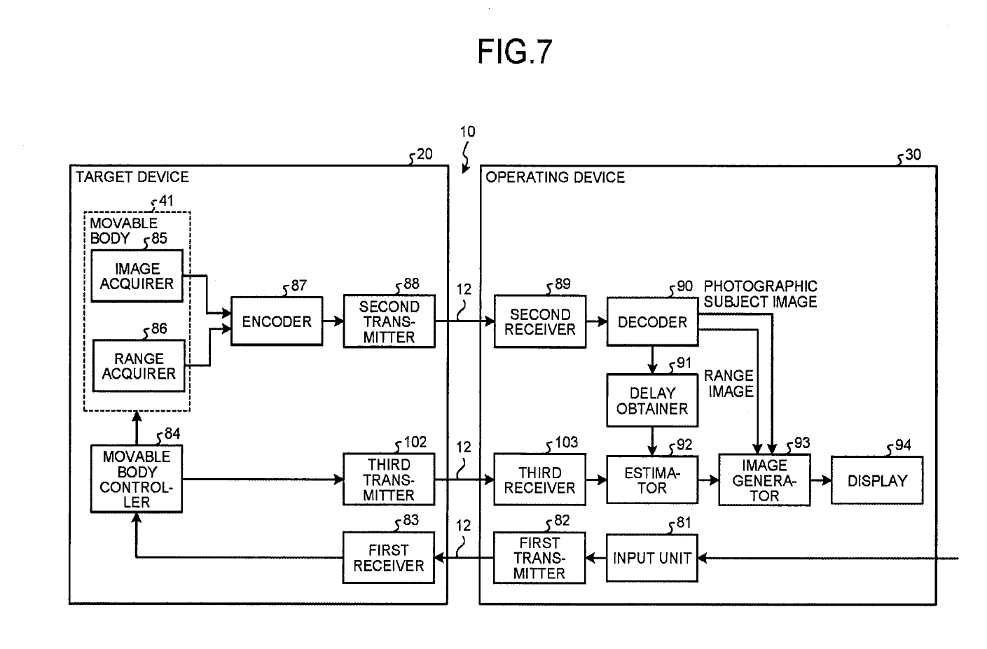

FIG. 7 is a diagram illustrating the remote control system 10 according to a third modification.

According to the third modification example, the target device 20 further includes a third transmitter 102. Moreover, according to the third modification, the operating device 30 further includes a third receiver 103.

The third transmitter 102 acquires the movement information of the movable body 41 from the movable body controller 84, and transmits the movement information to the operating device 30 through the network 12. For example, there are times when the movable body controller 84 makes the movable body 41 move automatically according to a computer program registered in advance in the target device 20. Moreover, in general, there are times when the expected movement of the movable body 41 according to the control information is different than the actual movement due to various external factors (such as wind, a water current, or the weight of an object placed on the movable body). Hence, there are times when the movable body controller 84 detects the position of the movable body 41 using a sensor and performs precise movement control. In such a case, the movable body controller 84 can output precise movement information.

The third receiver 103 acquires the movement information of the movable body 41 from the target device 20 through the network 12. Then, according to the third modification, based on the movement information received by the third receiver 103, the estimator 92 estimates the difference in viewpoint between the image capturing device 43 at the first timing, at which a photographic subject image is taken, and the image capturing device 43 at the second timing. Alternatively, the estimator 92 can estimate the difference in viewpoint based on the movement information received by the third receiver 103 and the control information received by the input unit 81.

In this way, according to the third modification, the remote control system 10 estimates the difference in viewpoint in the imaging viewpoints using the movement information, which is output from the movable body controller 84, either as substitute for the control information input by the operator or along with using the control information input by the operator. As a result, in the remote control system 10, it becomes possible to display a more accurate predicted image.

Fourth Modification

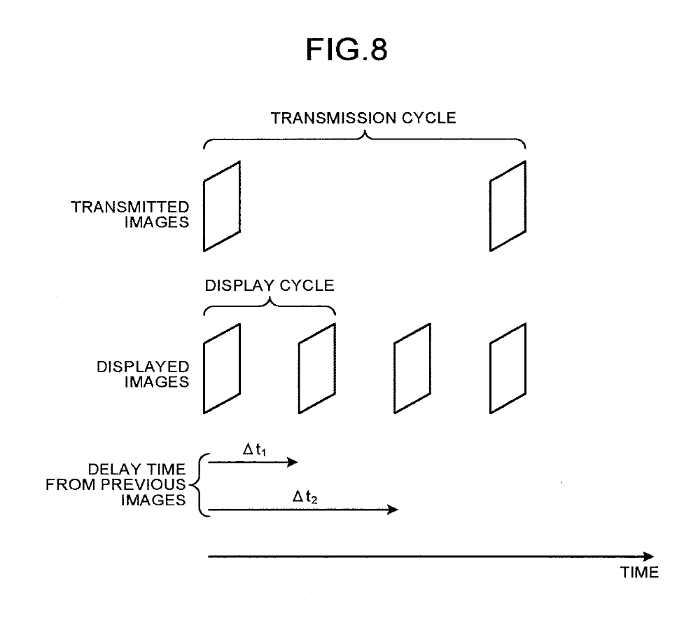

FIG. 8 is a diagram illustrating an example of the transmission cycle and the display cycle of images in the remote control system 10 according to a fourth modification.

Due to the effect of the performance of the image capturing device 43, the range image acquiring device 44, the image acquirer 85, the range acquirer 86, or the encoder 87, or due to the effect of the route from the second transmitter 88 to the second receiver 89 (for example, due to the effect of the band frequency of the network 12); there are times when a photographic subject image and a range image are transmitted at a slower transmission cycle than the display cycle of images as illustrated in FIG. 8.

In this case, in order to up-convert the image cycle, a photographic subject image corresponding to a displaying timing at which no image was received is generated by the image generator 93 based on the photographic subject image and the range image received immediately before. Herein, the delay obtainer 91 obtains a different delay time for each displaying timing. Thus, to the delay time of the previously-received photographic subject image, the delay obtainer 91 adds the delay (for example, A₁ and A₂ illustrated in FIG. 8) from the further-previously-received photographic subject image to the displaying timing, and outputs the resultant amount of time. Then, for each displaying timing, the estimator 92 calculates the difference in viewpoint based on the delay time obtained by the delay obtainer 91.

As a result, for each displaying timing, the image generator 93 can generate a different predicted image. Consequently, in the remote control system 10 according to the fourth modification, even if the transmission cycle is slower than the display cycle of images, it becomes possible to display predicted images in which the imaging viewpoints move in a smooth fashion.

Meanwhile, for example, in the case in which some portion of a photographic subject image or a range image cannot be acquired due to a transmission error; the image generator 93 can generate, in an identical manner, the photographic subject image of the display timing at which the transmission error occurred. Alternatively, the image generator 93 can generate, in an identical manner, only the portion in the photographic subject image for which the transmission error occurred. Hence, in the remote control system 10 according to the fourth modification, even if some portion of an image cannot be acquired due to a transmission error, it becomes possible to predict and display the image that could not be acquired.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
a processor; and
a memory to store processor-executable instructions that, when executed by the processor, cause the processor to:
acquire a first image captured at a first timing by an imager that is mounted on a movable body;
acquire a range image that represents a distance to a subject;
estimate a difference in viewpoint of the imager between at the first timing and at a second timing that is different than the first timing, based on movement information of the movable body; and
generate a second image that is predicted to be captured by the imager at the second timing based on the first image, the range image, and the difference in viewpoint.

2. The device according to claim 1, wherein the processor further performs:
obtaining a delay time from the first timing to the second timing; and
estimating the difference in viewpoint based on the delay time.

3. The device according to claim 1, wherein the processor further performs:
receiving control information to control movement of the movable body; and
estimating the difference in viewpoint based on the control information.

4. The device according to claim 1, wherein the processor further performs:
obtaining a response time of the movable body; and
estimating the difference in viewpoint based on the response time.

5. The device according to claim 1, wherein the second timing indicates a timing at which the second image is to be displayed on a display.

6. The device according to claim 1, wherein the difference in viewpoint represents a difference in position of the imager between at the first timing and at the second timing.

7. The device according to claim 1, wherein the difference in viewpoint represents a difference in direction of the imager between at the first timing and at the second timing.

8. The device according to claim 1, further comprising:
a communicator to receive the first image and the range image at a transmission rate slower than a display rate of images through a network.

9. The device according to claim 8, wherein the processor further generates the second image corresponding to a displaying timing based on the first image and the range image that are lastly received.

10. The device according to claim 2, wherein the processor further performs:
acquiring the first image and a timestamp representing the first timing; and
calculating the delay time based on the timestamp.

11. The device according to claim 2, further comprising:
a communicator to receive an encoded first image through a network; and
a decoder to decode the encoded first image and generate the first image, wherein
the processor further obtains the delay time that includes a delay caused by an encoding operation.

12. The device according to claim 1, wherein the processor further generates the range image based on an image captured by the imager.

13. A system comprising:
an imager mounted on a movable body;
the device according to claim 1 that processes with respect to an image captured by the imager; and
a display to display an image generated by the device.

14. The system according to claim 13, further comprising the movable body.

15. An image processing method comprising:
acquiring a first image captured at a first timing by an imager that is mounted on a movable body;
acquiring a range image that represents a distance to a subject;
estimating, based on movement information of the movable body, a difference in viewpoint of the imager between at the first timing and at a second timing that is different than the first timing; and
generating, based on the first image, the range image, and the difference in viewpoint, a second image that is predicted to be captured by the imager at the second timing.
